(19) United States
(12) Patent Application Publication
(10) Pub. No.: US 2003/0195794 A1
(43) Pub. Date: Oct. 16, 2003

(54) Manufacture managing method

(76) Inventor: To-Oru Yasuda, Tokyo (JP)

Correspondence Address: BURNS, DOANE, SWECKER & MATHIS, L.L.P., P.O. Box 1404, Alexandria, VA, 22313-1404, US

(21) Appl. No.: 10/270,110

(22) Filed: Oct. 15, 2002

(30) Foreign Application Priority Data
Apr. 15, 2002 (JP) 2002-112465

(51) Int. Cl. G06F 17/60

(52) U.S. Cl. 705/10; 705/37

(57) ABSTRACT

Management information is collected from a plurality of production lines that are distributed to a plurality of factories or foundries. Manufacturing schedules of the respective apparatuses constituting each production line are drawn up based on the collected management information and data stored in a database beyond the framework of each factory or foundry so that the entire manufacturing efficiency is increased. Then, production lines (apparatuses) are selected according to the schedules thus determined and product lots are managed and transport arrangements are made so that manufacturing steps of a product are executed by the selected production lines (apparatuses).

### BACKGROUND OF THE INVENTION

1. Field of the Invention

The present invention relates to a manufacture managing method and, more specifically, to a method for optimizing a productmix in manufacturing many kinds of products with a plurality of production lines.

2. Background Art

In factories of manufacturing semiconductor devices, the kinds of apparatuses that constitute each production line depend on the kinds of semiconductor devices to be manufactured by the line. Therefore, to construct a new production line, usually, a form of mixing of devices to be manufactured by the line (i.e., a productmix) is assumed and apparatuses to constitute the line are selected accordingly.

However, the generational change of semiconductor devices is very fast and the period of manufacture of each product type is very short. Therefore, it is often the case that after a lapse of one or two years from the start of a production line the form of product mixing is much different from the one that was assumed at the start. This may cause a situation that among the apparatuses constituting the production line one is insufficient in processing ability and another is not used frequently, as a result of which the manufacturing efficiency is no longer commensurate with the investment.

Usually, scheduling and management of manufacture are performed on a production line basis and a factory basis. Therefore, a manufacturing schedule involving a plurality of production lines is determined by making up schedules of respective lines and then integrating those.

However, it is very difficult for such a stepwise method of scheduling and managing manufacture to realize an optimum productmix. For example, when the manufacturing ability of a certain production line has lowered steeply due to an apparatus failure, for example, it takes long time to find and substitute an equivalent apparatus, if any, in another line. Even if ongoing manufacture of a certain product is canceled suddenly to cause excess ability in the manufacturing line, the excess ability cannot be used effectively.

### SUMMARY OF THE INVENTION

An object of the present invention is to enable effective functioning of a plurality of production lines that are distributed to a plurality of factories or foundries and to thereby always realize an optimum productmix.

The term “a plurality of production lines” is not necessarily limited to lines in one factory of one maker. In this connection, there is a case that production lines are shared by makers belonging to the same business category to increase the efficiency of investment. There is another case that a company that has determined a design of a chip by itself entrusts the manufacture of the chip to a plurality of companies that are dedicated to chip manufacture (foundries). The invention encompasses such cases in which manufacture is performed beyond the framework of each maker or factory, and intends to increase the efficiency of manufacture in such a manner.

According to one embodiment of the present invention, a manufacture managing method includes three steps. A first step is collecting pieces of management information of a plurality of production lines. A second step is making up manufacturing schedules of respective manufacturing apparatuses constituting each of the production lines based on the collected pieces of management information. A third step is selecting a most suitable one from the production lines based on the manufacturing schedules.

Preferably, data of transport times and/or transport costs of items between the production lines are managed, and the making-up step refers to the data in making up manufacturing schedules.

The manufacture managing method may include the step of receiving a specification from a production requester. The making-up step makes up manufacturing schedules of respective manufacturing apparatuses based on the received specification and the collected management information.

Other and further objects, features and advantages of the invention will appear more fully from the following description.

### BRIEF DESCRIPTION OF THE DRAWINGS

The present invention will be more apparent from the following detailed description, when taken in conjunction with the accompanying drawings, in which;

FIG. 1 shows a manufacture managing system according to a first embodiment of the invention;

FIG. 2 is a flowchart showing a process that is executed by a manufacture managing apparatus of the system in FIG. 1;

FIG. 3 shows an example of management information;

FIG. 4 shows an example of information in a database;

FIG. 5 shows another example of information in a database;

FIG. 6 is a flowchart showing a process that is executed by the manufacture managing apparatus;

FIG. 7 shows a process when a failure has occurred in a apparatus of a production line;

FIG. 8 shows a manufacture managing system according to the second embodiment of the invention; and

FIG. 9 is a flowchart showing an estimation and order reception process that is executed by a manufacture managing apparatus of the system in FIG. 8.

### DETAILED DESCRIPTION OF THE PREFERRED EMBODIMENTS

Embodiments of the present invention will be hereinafter described with reference to the accompanying drawings.

First Embodiment

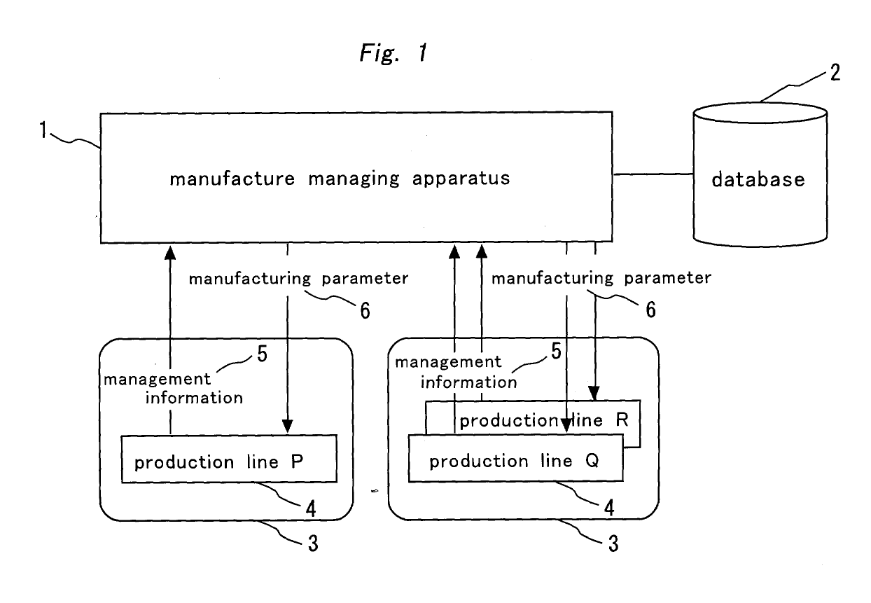

FIG. 1 shows a manufacture managing system according to a first embodiment of the invention that employs a method according to the invention. A manufacture managing apparatus 1 is connected to a plurality of factories 3 via a network and is so configured as to be able to use various data of a database 2. The network may be dedicated lines, a private network such as a VPN (virtual private network), commercial telephone lines, or a general-purpose network such as the Internet. The database 2 may be one that is managed by the manufacture managing apparatus 1 itself or one that is managed by a database server that does not belong to the manufacture managing apparatus 1.

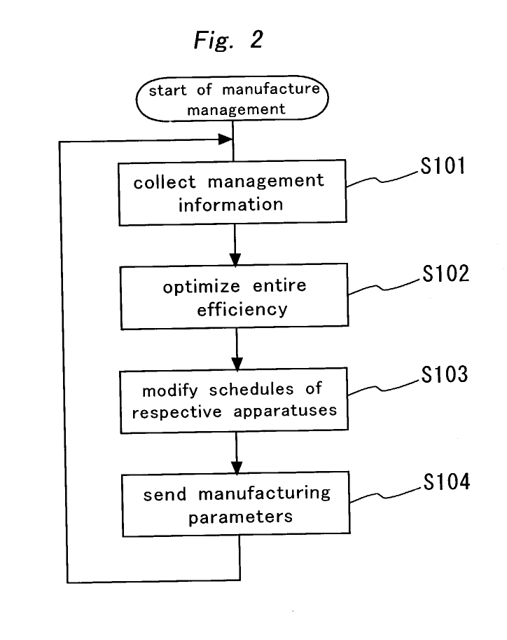

FIG. 2 is a flowchart showing a process that is executed by the manufacture managing apparatus 1. The process that is executed by the manufacture managing apparatus 1 will be described below by referring to FIGS. 1 and 2 in a parallel manner. As shown in FIG. 1, the manufacture managing apparatus 1 collects, over the network, management information 5 from production lines 4 of the factories 3 or control devices or the like that control the production lines 4 (step S101 in FIG. 2).

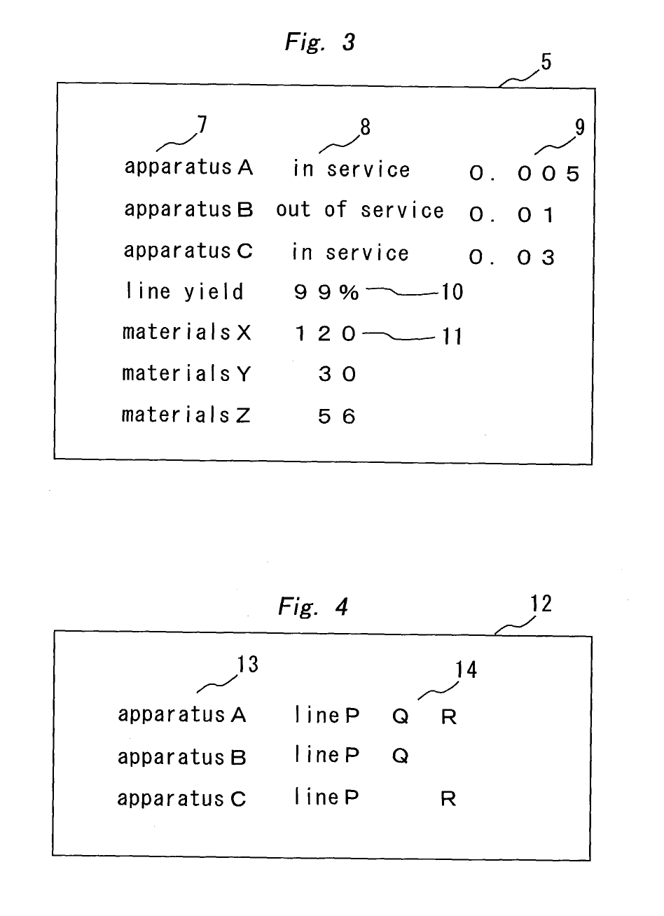

The management information 5 is index information indicating, for example, whether manufacture is going on as scheduled, no abnormality is found in the apparatuses constituting a production line 4, the quality of products being manufactured is good, or any excess parts or materials exist. As shown in FIG. 3, the manufacture managing apparatus 1 according to this embodiment collects pieces of management information 5 each of which contains operation states 8 of respective apparatuses 7 constituting a production line 4, performance-indicative values (densities of defects) 9 of the respective apparatuses 7, a line yield 10, and the numbers 11 of parts and materials in stock that are to be used for manufacture. However, this example does not restrict the details of the management information 5; it goes without saying that any other kind of information that is necessary for manufacture management can be employed as part of each piece of management information 5.

If judging that there exists a trouble (e.g., a failure or a reduction in the level of quality) by checking the collected management information 5, the manufacture managing apparatus 1 takes a necessary measure to eliminate the trouble as the entire system without being bound by the framework of the factory 3 where the trouble exists. Specifically, the manufacture managing apparatus 1 modifies the entire schedule to maximize the manufacturing efficiency of the entire system (step S102 in FIG. 2), modifies the manufacturing schedules of the respective apparatuses constituting each production line 4 so that they reflect the modified entire schedule (step S103 in FIG. 2), and sends manufacturing parameters 6 (see FIG. 1) to the factories 3 based on the modified manufacturing schedules of the respective apparatuses (step S104 in FIG. 2). “High manufacturing efficiency” means that high-quality products can be manufactured in a short time at a low cost. The order of priority among the time, cost, and quality is not fixed because it depends on the policy of a person who is responsible for a product. It is preferable to make it possible to determine the order of priority on a system-by-system basis.

The manufacturing parameters 6 are manufacturing instructions to the apparatuses of each production line 4 and include a flow of manufacture indicating a processing schedule and process parameters such as temperatures and times. The manufacturing parameters 6 may also include parameters indicating product specifications. For example, if the product is a transistor, a threshold voltage and a response speed of the transistor, a pitch of interconnections, the number of layers, and an integration density may be passed to the apparatuses of a production line 4 as manufacturing parameters 6.

In modifying a schedule, the manufacture managing apparatus 1 uses the various information stored in the database 2. Data that are necessary to optimize the manufacturing efficiency are stored in the database 2. For example, when one of the apparatuses constituting a certain production line 4 has failed, the manufacturing efficiency can be increased by temporarily using an apparatus of the same type, if any, in another production line 4. To this end, it is necessary to prepare, in advance, data 12 each of which correlates an apparatus 13 with production lines 14 having it, as shown in FIG. 4.

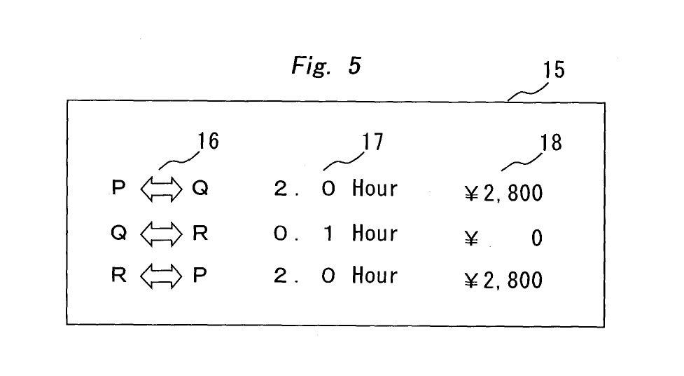

However, attention should be paid to the fact that the use of a substitute apparatus does not necessarily increase the efficiency if a transport time and cost are taken into consideration. FIG. 5 shows data 15 each of which correlates a transport path 16 with a transport time 17 and a transport cost 18. By storing such data in advance in the database 2 in such a manner as to be used when necessary, optimization processing can be performed based on a transport time and cost.

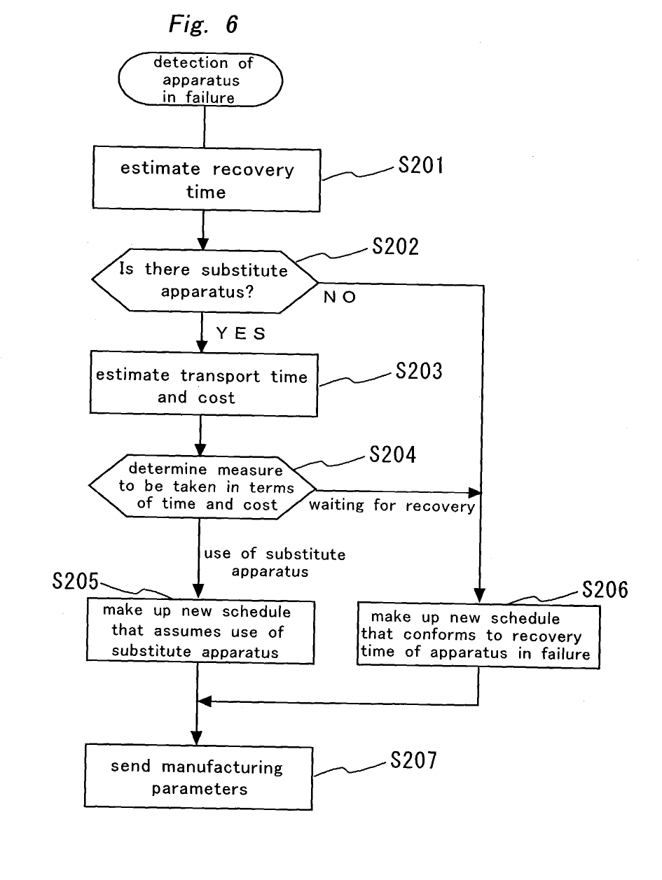

FIG. 6 is a flowchart showing a process that is executed by the manufacture managing apparatus 1 when a failure has been found in a certain production line 4. When detecting, based on operation states 8 of collected management information 5, that an apparatus is not in operation though it should, the manufacture managing apparatus 1 judges that the apparatus is in failure and estimates a time when it will be recovered (step S201). A recovery time is estimated by retrieving past maintenance records etc. from the database 2.

Then, the manufacture managing apparatus 1 judges whether there exists an apparatus to replace the apparatus in failure by referring to the data 12 that correlates the apparatuses 13 with the lines 14 (step S202). If there is no substitute apparatus, the manufacture managing apparatus 1 performs rescheduling in such a manner as to, for example, shift the manufacturing schedules of the respective apparatuses so that they conform to the recovery time that was estimated at step S201 or advance the processing times of steps, if any, that can be executed earlier (step S206). If there exists a substitute apparatus, the manufacture managing apparatus 1 estimates a time and a cost of transporting the substitute apparatus based on the data 15 shown in FIG. 5 (step S203).

At step S204, the manufacture managing apparatus 1 compares waiting for recovery of the apparatus in failure with transporting halfway products to the production line of the substitute apparatus in terms of the time and cost, and judges which measure is preferable to increase the manufacturing efficiency. Judgment criteria may be determined as part of design items. However, it is desirable that the manager be able to set judgment criteria at his discretion, because the order of priority among the cost, time, quality, etc. varies depending on the customer of a product, the time of delivery, and other factors.

If it is judged at step S204 that waiting for recovery of the apparatus in failure is advantageous, at step S206 the manufacture managing apparatus 1 makes up a new schedule that conforms to the estimated recovery time. If a next start time of a step where the apparatus in failure is scheduled to be used is after the estimated recovery time, no rescheduling is necessary. On the other hand, it is judged at step S204 that continuing the manufacture using the substitute apparatus is advantageous, the manufacture managing apparatus 1 makes up a new schedule that assumes use of the substitute apparatus (step 205).

Whichever of step S205 or S206 has been executed, manufacture managing apparatus 1 sends manufacturing parameters 6 to the manufacturing apparatuses of each production line 4 based on the new schedule (step S207).

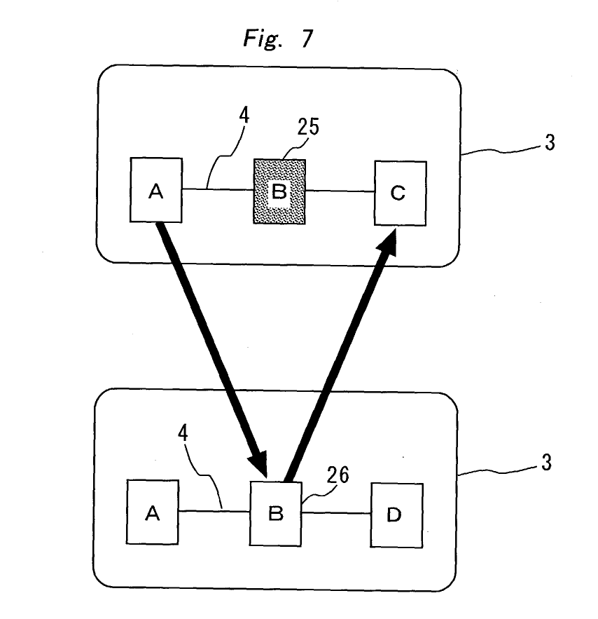

As shown in FIG. 7, when a failure has occurred in an apparatus 25 of the production line 4 of a certain factory 3, if judging from the view point of the transport time and cost that use of a substitute apparatus 26 is advantageous, the manufacture managing apparatus 1 makes up a new entire schedule that assumes the use of the substitute apparatus 26. Further, based on the new schedule, the manufacture managing apparatus 1 selects a production line 4 (apparatuses) for each manufacturing step. At a time point when the production lines have been selected after the rescheduling, the manufacture managing apparatus 1 may give sending and return instructions to a transport section by informing it of the selected production lines. In this manner, products can always be manufactured efficiently by effectively using all usable manufacturing apparatuses beyond the framework of each factory.

Although the above description is directed to the case that rescheduling is performed when an apparatus has failed, the invention is not limited to such a case. The manufacturing efficiency can also be increased by rescheduling in a case that an appointed date of delivery may not be met due to insufficient processing ability of an apparatus though it is not in failure or in a case that a prescribed level of quality can no longer be satisfied constantly or the yield of a production line has lowered due to reduction in the performance of an old apparatus.

If there is a cause of interrupting a manufacturing step that does not relate to any apparatuses themselves of a production line, rescheduling may be performed after the cause has been eliminated. For example, if the manufacture managing apparatus 1 has found, by collecting management information 5, an apparatus that cannot do its job due to an insufficient stock of a part or a material, it is appropriate to perform rescheduling after purchasing the part or material by a necessary number of pieces or amount.

Second Embodiment

The manufacture managing apparatus 1 according to the first embodiment is intended to keep the manufacturing efficiency of the entire system always high by making up a new schedule mainly when a certain trouble has occurred in a production line. In contrast, a manufacture managing apparatus according to a second embodiment is mainly intended to make up a schedule capable of satisfying requirements of a production requester and proposes the schedule to the manufacture requester. In the second embodiment, the same components of the system and the same steps of the process as in the first embodiment will not be described.

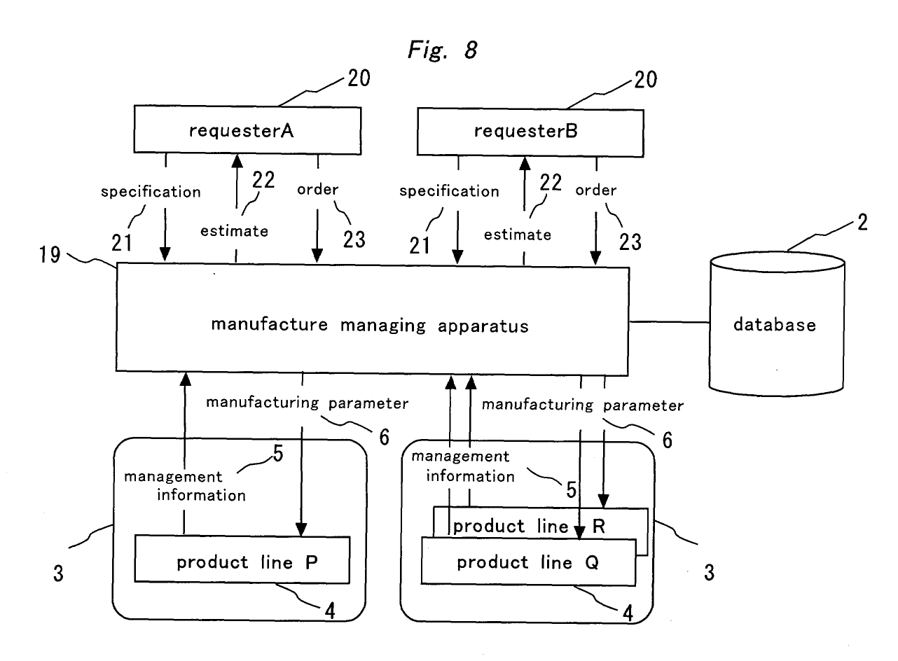

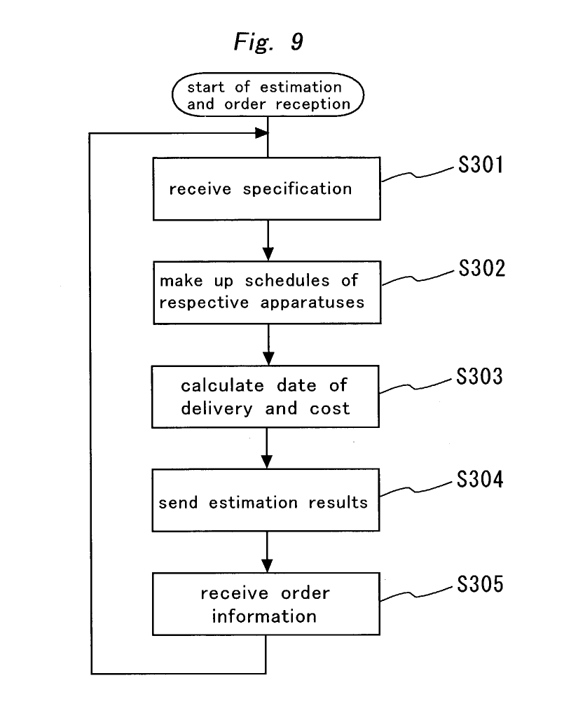

FIG. 8 shows a manufacture managing system according to the second embodiment of the invention that employs a method according to the invention. FIG. 9 is a flowchart showing an estimation and order reception process that is executed by a manufacture managing apparatus 19. As seen from FIGS. 8 and 9, the manufacture managing apparatus 19 have the following five new functions in addition to the functions of the manufacture managing apparatus 1 according to the first embodiment. The first function is a function of receiving a specification 21 for an intended product from a production requester 20 (step S301). The second function is a function of making up schedules of respective apparatuses to be used for manufacturing the product that satisfies the received specification (step S302). The third function is a function of calculating a date of delivery and a cost that are expected with the schedules thus determined (step S303). The fourth function is a function of sending an estimate 22 including the calculated date of delivery and cost to the production requester 20 (step S304). The fifth function is a function of receiving an order 23 from the production requester 20 when the production requester 20 has decided to order manufacture of the product under the conditions of the estimate 22 (step S305). In this embodiment, to decrease the communication cost, communications with the production requester 20 are performed over telephone lines or the Internet. In this case, it is desirable to exchange coded communication data.

In sending a specification 21 to the manufacture managing apparatus 19, a production requester 20 uses a data format that is specified by the manufacture managing apparatus 19. This allows the manufacture managing apparatus 19 to receive information that is necessary to make up schedules from the production requester 20 in a reliable manner. The specification 21 may include, in addition to specifications of the product itself (e.g., dimensions), conditions of a manufacturing process of the product. The specification 21 may further include process parameters such as manufacturing flow temperatures and times and detailed requests for the product such as a threshold voltage of a transistor and an integration density.

Assume that the manufacture managing apparatus 19 which belongs to a semiconductor device manufacture managing system has received, from a production requester 20, a flow of manufacture including wafer oxidation, film deposition, ion implantation, and etching and process parameters of those steps (e.g., film thickness, the degree of ion doping, and etching depth). In this case, the manufacture managing apparatus 19 reads data as shown in FIGS. 3-5 from the database 2, collects management information 5 from the factories 3, and makes up a manufacturing schedule for the requested product.

The manufacture managing apparatus 19 makes up two kinds of schedules, that is, a schedule in which preference is given to the cost and a schedule in which the preference is given to the date of delivery. If there is a possibility that the quality will vary depending on the production lines 4 (or apparatuses) used, another schedule may be drawn up in which preference is given to the quality.

The manufacture managing apparatus 19 replies to the production requester 20 by sending it estimates 22 each of which includes a date of delivery and a cost that are expected by a manner of manufacture according to each schedule thus determined. The production requester 20 selects one of the estimates that is satisfactory from a plurality of estimates 22 and sends order information 23 to the manufacture managing apparatus 19. The manufacture managing apparatus 19 selects production lines 4 to be used based on the schedule corresponding to the estimate that has been selected by the production requester 20.

The manufacture managing apparatus 19 according to this embodiment is particularly effective in the case where a plurality of factories 3 and production lines 4 are distributed to different foundries. This is because a production requester 20 need not do estimation-related negotiations with a plurality of foundries individually; the production requester 20 can receive a plurality of estimates (replies) by merely sending specifications 21. This system is also convenient to each foundry because it can receive orders from a plurality of production requesters 20 and hence can increase the efficiency of utilization of its production lines 4.

It is appropriate to communicate a specification 21 received from a production requester 20 to production lines in the form of manufacturing parameters 6 after receiving a formal order. This is because if a device maker as a production requester 20 and a foundry are in a competitive relationship, disclosure of the specification at the estimation stage may be very detrimental to the device maker. The intervention of the manufacture managing apparatus 19 eliminates such fear of leakage of secret items to a foundry.

Third Embodiment

A third embodiment is such that the rescheduling according to the first embodiment is performed after the start of manufacture of an ordered product in the manufacture managing system according to the second embodiment.

In general, halfway products are rarely exchanged between foundries that are in a competitive relationship. However, where a third party who is neither a device maker or a foundry provides a mediation service using a manufacture managing apparatus, there may occur an event that when a trouble has occurred in an apparatus belonging to a certain foundry, a substitute apparatus belonging to another foundry is used.

This system is preferable because a production requester can have a product manufactured in a short time at a low cost without giving any consideration to a competitive relationship between foundries. This system is also convenient to each foundry because it can use its production lines effectively and hence can maintain high manufacturing efficiency.

In the manufacture managing method according to the invention, schedule of respective manufacturing apparatuses are drawn up by collecting management information from a plurality of production lines that are distributed to a plurality of factories of a company concerned or a plurality of foundries. Therefore, most suitable schedules can be drawn up quickly with a little labor when it is necessary to modify schedules due to a failure in an apparatus or when a production requester wants to receive a lot of estimates to determine a company to which to request manufacture of a product.

It is further understood that the foregoing description is a preferred embodiment of the disclosed method and that various changes and modifications may be made in the invention without departing from the spirit and scope thereof.

The entire disclosure of a Japanese Patent Application No.2002-112465, filed on Apr. 15, 2002 including specification, claims drawings and summary, on which the Convention priority of the present application is based, are incorporated herein by reference in its entirety.

1. A manufacture managing method comprising the steps of:
collecting pieces of management information of a plurality of production lines;
making up manufacturing schedules of respective manufacturing apparatuses constituting each of the production lines based on the collected pieces of management information; and
selecting a most suitable one from the production lines based on the manufacturing schedules.

2. The manufacture managing method according to claim 1, wherein data of transport times and/or transport costs of items between the production lines are managed, and wherein the making-up step refers to the data in making up manufacturing schedules.

3. The manufacture managing method according to claim 1, wherein the management information includes operation states of respective apparatuses constituting the associated production line.

4. The manufacture managing method according to claim 1, wherein the management information includes a yield of the associated production line.

5. The manufacture managing method according to claim 1, wherein the management information includes performance-indicative values of respective apparatuses constituting the associated production line.

6. The manufacture managing method according to claim 1, wherein the management information includes a stock of parts and materials of the associated production line.

7. The manufacture managing method according to claim 1, further comprising the step of receiving a specification from a production requester, wherein the making-up step makes up manufacturing schedules of respective manufacturing apparatuses based on the received specification and the collected management information.

8. The manufacture managing method according to claim 7, wherein the making-up step makes up plural sets of manufacturing schedules, and wherein the manufacture managing method further comprises the step of presenting a plurality of estimates to the production requester based on the plural sets of manufacturing schedules to allow the production requester to make an order by selecting from the estimates.
